(19) United States
(12) Patent Application Publication
(10) Pub. No.: US 2008/0059897 A1
(43) Pub. Date: Mar. 6, 2008

(54) METHOD AND SYSTEM OF SOCIAL NETWORKING THROUGH A CLOUD

(75) Inventor: MICHELE DILORENZO, BEVERLY HILLS, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: WHATTOREAD, LLC, BEVERLY HILLS, CA (US)

(21) Appl. No.: 11/469,857

(22) Filed: Sep. 2, 2006

(51) Int. Cl. G06F 3/048

(52) U.S. Cl. 715/764

(57) ABSTRACT

A method of social networking is disclosed. The method displays a user name on a web page. Further, the method receives an input that selects the user name. The method displays a display cloud, for the user name that is selected, that illustrates at least a subset of a personal cloud of the user associated with the user name. Furthermore, multi-level tagging for content can be used in order to generate tag clouds.

### BACKGROUND

1. Field

A method and system are disclosed, which generally relate to social networking.

2. General Background

The Internet has increased in usage to the point that that the Internet is a part of many people's everyday lives. Further, the Internet has become an environment in which social networking can occur. Social networking is the ability for a user to interact with other users who may have some common interests. This interaction can take place over the Internet, or any other type of computer network.

A number of social networking web sites have been developed and are becoming increasingly popular. The majority of these web sites allow a user to post a profile page that describes the various interests that the user may have. For instance, the user can post pictures, songs, text, blogs, essays, etc. directed toward his or her interests. Further, the profile page generally provides a list of friends of the user. Another user can visit the profile page of the user and click on links to each one of the friends. By clicking on the link, the other user can visit the web page of each one of the friends. After visiting a web page of one of the friends, a user can communicate with the friend. For instance, the user can send an instant message or an e-mail to the friend whose web site the user has visited.

While social networking sites are increasing in popularity, they are limited in establishing networking opportunities. In other words, current social networking sites are based on the friend model and, thereby, are mainly directed to introducing a user to friends of another. Users that share common interests may never get to meet each other according to the friend model.

### SUMMARY

In one aspect of the disclosure, a method of social networking is disclosed. The method displays a user name on a web page. Further, the method receives an input that selects the user name. The method displays a display cloud, for the user name that is selected, that illustrates at least a subset of a personal cloud of the user associated with the user name.

In another aspect of the disclosure, a method of social networking is disclosed. The method provides a search engine that searches through a plurality of personal clouds. Each of the personal clouds is displayed on a personal page and provides a visual display of tags that users have utilized to tag content. Further, the method receives one or more tags as search criteria. In addition, the method searches through the plurality of personal clouds for the one or more tags.

In another aspect, there is a method of interrelating multilevel tagged content in a computer network. A topic web page having a main topic is displayed. A direct tag cloud that includes a plurality of first level tags and a plurality of second level tags that have been used to tag one or more content items can be displayed. At least one first level tag used to tag the one or more content items includes the main topic. The direct tag cloud can be displayed on the topic web page.

In addition, an indirect tag cloud that includes a plurality of first level tags and a plurality of second level tags that have been used to tag one or more content items can be generated. At least one second level tag used to tag the one or more content items includes the main topic. The indirect tag cloud can also be displayed on the topic web page.

In another aspect of the disclosure, a method of social networking is disclosed. The method performs a search through a network for a search term. Further, the method receives search results from the search. In addition, the method also displays, based upon the search results, a content listing that lists content which has been tagged with the search term. The method also displays, based upon the search results, a cloudmember cloud that includes a visual arrangement of user names associated with users that have utilized the search term as a tag.

In another aspect, there is a method of referencing content on a website. At least one first level tag and at least one second level tag to tag a content item are received. The at least one first level tag can have a higher degree of relevance to the content item than the at least one second level tag. A tag cloud that displays one or more tags related to the content item is generated. At least a portion of the tags displayed in the tag cloud are at least partially weighted based on the degree of relevance of the at least one first level tag and the at least one second level tag to the content item.

### DRAWINGS

The above-mentioned features and objects of the present disclosure will become more apparent with reference to the following description taken in conjunction with the accompanying drawings wherein like reference numerals denote like elements and in which:

FIG. 1A illustrates the personal page having a personal cloud that includes a plurality of content tags.

FIG. 1B illustrates the personal page having a personal cloud that includes a plurality of biographical tags.

FIG. 1C illustrates the personal page having a personal cloud that includes a plurality of content tags and a plurality of biographical tags.

FIG. 2 illustrates a process for creating a personal cloud.

FIG. 3 illustrates a topic page, which can be composed from the content tags of various personal pages.

FIG. 4 illustrates a process that creates the cloudmember cloud.

FIG. 5 illustrates an input display.

FIG. 6A illustrates a display cloud that can be displayed in conjunction with the cloudmember cloud on the topic page.

FIG. 6B illustrates an exemplary additional display cloud that can be displayed in conjunction with the display cloud.

FIG. 6C illustrates an exemplary additional display cloud that can be displayed in conjunction with a topic tag cloud.

FIG. 7 illustrates a process that creates a display cloud.

FIG. 8 illustrates a process 800 for displaying a display cloud.

FIG. 9 illustrates an input box 900 that allows a user to input one or more main topic tags 902 and one or more related tags 904 for a piece of content.

FIG. 10A illustrates a main topic tag view.

FIG. 10B illustrates a related tag view.

FIGS. 11A-11B illustrate processes for interrelating content that has been tagged with multilevel tags.

FIG. 12 illustrates a web page 1200 that depicts the search results from a search for the tag.

FIG. 13 illustrates a process 1300 that displays search results from searching for a tag.

FIG. 14 illustrates a process 1400 that provides cloud matching.

FIG. 15 illustrates a system 1500 that can be utilized to create the clouds described herein.

### DETAILED DESCRIPTION

A social networking method and system are disclosed. In one embodiment, the social network method and system are based on a topic model as opposed to a friend model. In other words, users can create connections and relationships between topics of interest. Each user can have a personal page, which may also be referred to as a profile page, that can display topics of interest and/or information that describes the user. This information can provide a gateway to networking with other users with similar interests.

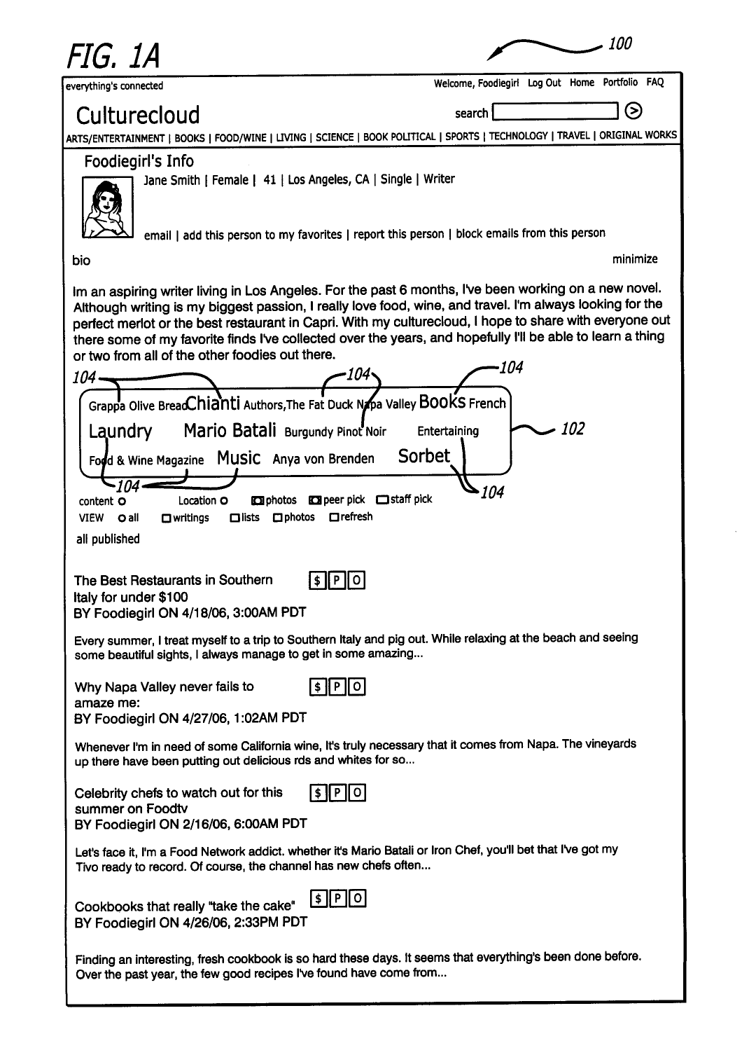

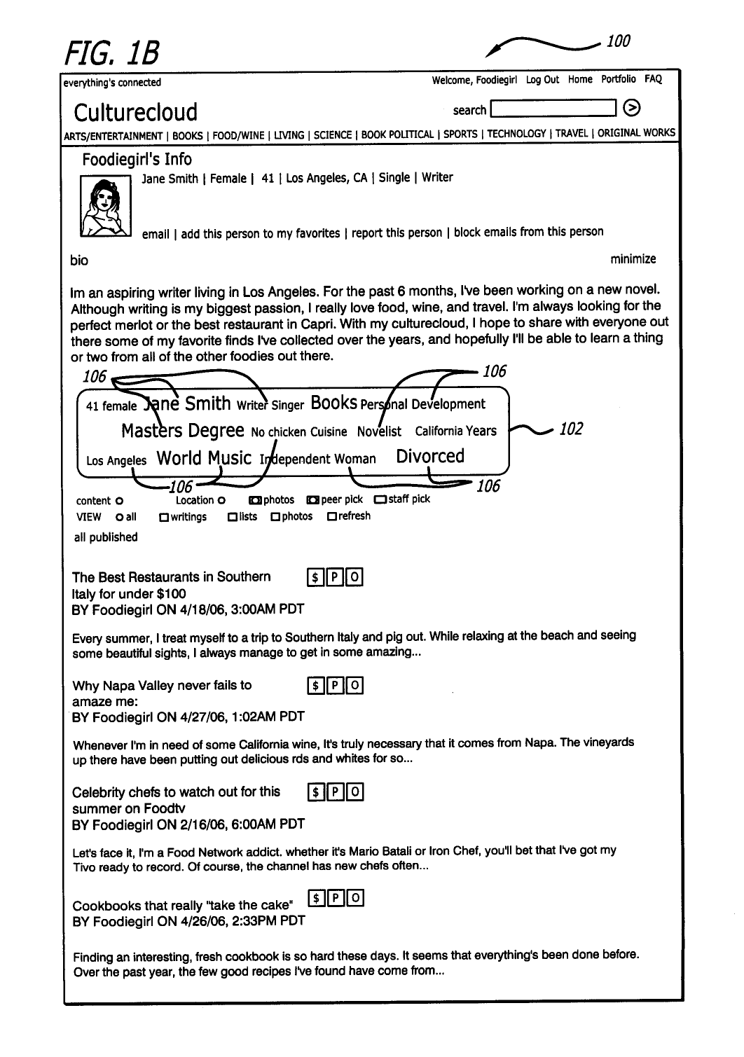

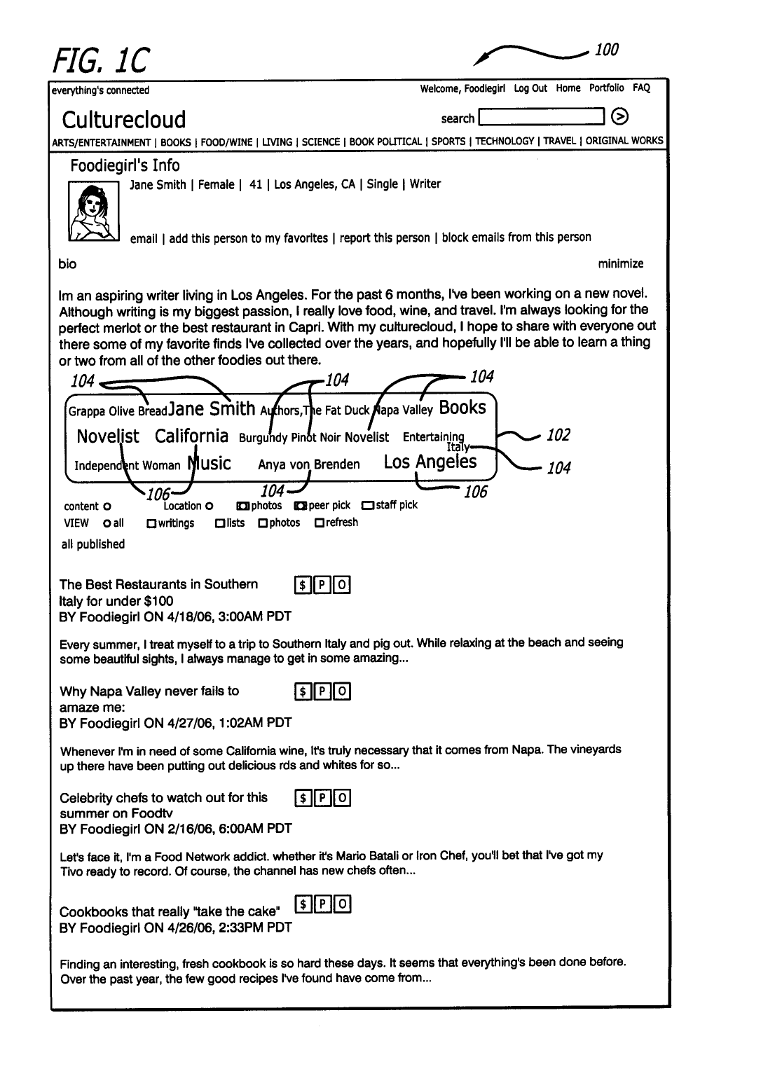

FIGS. 1A-1C illustrate variations of a personal page 100 that can be created for a user. For instance, FIG. 1A illustrates the personal page 100 having a personal cloud 102 that includes a plurality of content tags 104. Each of the content tags 104 can include a word or phrase that is utilized to describe content. The term content is intended to include a writing, image, blog, photograph, audio, video, etc. For instance, a user may tag an essay that he or she has written with the content tags “technology” and “computers.” Further, the user can provide the content tags at the time that the content is uploaded. For instance, an input box can be provided on a web page to ask the user to provide tags for the essay. The user can then enter the tags “technology” and “computers” into the input box. In addition, the user can add additional content tags for the content after the content has been uploaded. Further, the user can modify existing tags for the content after the content has been uploaded. The personal cloud 102 is a visual arrangement of the content tags 104. For instance, the personal cloud 102 can be a weighted display of the content tags 104. In one embodiment, the content tags 104 can be displayed in alphabetical order. Further, the font of the content tags 104 can correspond to the frequency with which the content tags are utilized by the individual represented by the personal cloud 102. A large font can indicate that a content tag has been utilized very frequently where as a small font can indicate that a content tag has been utilized less frequently.

In one embodiment, the content tags 104 can each be assigned to a particular category based on the frequency that the content tag 104 is utilized by the user of the personal page 100. For instance, five frequency categories can be established such that each frequency category has a corresponding font size. Accordingly, a user viewing the personal cloud 102 of another user can obtain a snapshot view of the interests of that user to help the user determine whether he or she may want to interact with the other user. In one embodiment, the content tags 104 are hyperlinks and can be selected so that a list of pieces of content associated with the content tag can be viewed. Further, the list of pieces of content can include pieces of content written by the user that have been tagged by the user in addition to pieces of content that have been written and tagged by other users.

In one embodiment, the personal cloud 102 displays only a subset of the potential content tags 104. Further, the subset can be randomly determined prior to alphabetically displaying the content tags 104. The subset can also be determined to accommodate the size of the viewing display. In other words, a predetermined number of allowed content tags 104 can be established prior to the random selection of the subset to allow enough space to display the subset.

Further, FIG. 1B illustrates the personal page 100 having a personal cloud 102 that includes a plurality of biographical tags 106. Biographical tags are words or phrases utilized by a user to describe himself or herself. For instance, a biographical tag can be utilized to describe an affiliation with a political party, marital status, age, school affiliation, etc. These examples are meant to be only illustrative, not exhaustive. The personal cloud 102 is a visual arrangement of the biographical tags 106. In one embodiment, the biographical tags 106 appear in alphabetical order and are not weighted. In other words, the biographical tags appear in the same font.

In one embodiment, the personal cloud 102 displays only a subset of the potential biographical tags 106. Further, the subset can be randomly determined prior to alphabetically displaying the biographical tags 106. The subset can also be determined to accommodate the size of the viewing display. In other words, a predetermined number of allowed biographical tags 106 can be established prior to the random selection of the subset to allow enough space to display the subset.

In another embodiment, the personal cloud 102 displays a weighted visual arrangement of the biographical tags 106. The weighting can be determined by the user. For instance, the user may want to emphasize a political affiliation more than a hobby. In one embodiment, the weighting is visually represented through font size. Accordingly, the biographical tag 106 with a higher weighting appears in a larger font than a biographical tag 106 with a lower weighting.

FIG. 1C illustrates the personal page 100 having a personal cloud 102 that includes a plurality of content tags 104 and a plurality of biographical tags 106. In one embodiment, the tags of the personal cloud 102 can have multiple weightings. For instance, the content tags 104 can be weighted by frequency, as discussed above with respect to FIG. 1A. Further, the content tags 104 can be weighted with respect to the biographical tags 106. In other words, the content tags 104 can be emphasized with respect to the biographical tags 106. Accordingly, even a content tag 104 with a low frequency may have a larger font than a biographical tag 106. In another example, the biographical tags 106 can be weighted with respect to the content tags 104. In another example, the content tags 104 can be weighted with respect to each other according to frequency. Further, the content tags 104 can be weighted differently than the biographical tags 106 based on a multiplier. In other words, the content tags 104 can have a font size that is a multiple of the font size of the biographical tags 106.

Accordingly, the personal cloud 102 can provide a snapshot a user that includes a combination of interests related to content and personal descriptors. This combination can help provide a realistic snapshot of the qualities of a person so that people can better determine if they would like to interact with one another.

One of ordinary skill in the art will recognize a variety of possible visual representation mechanisms to illustrate weighting. Color, font styles, etc. can also be utilized to visually represent weighting.

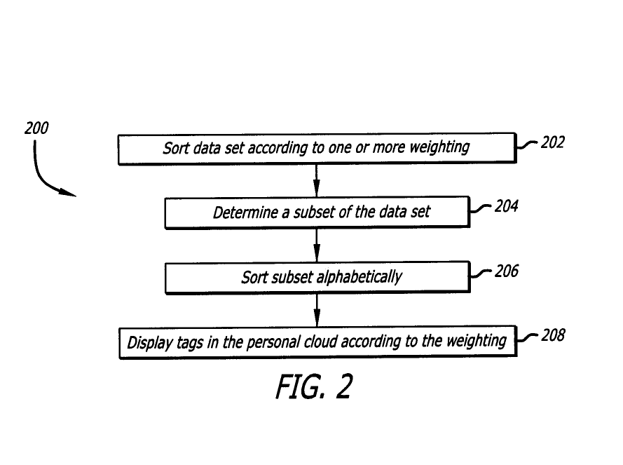

FIG. 2 illustrates a process 200 for creating a personal cloud 102. At a first process block 202, a data set is sorted according to one or more weightings. As discussed above, the content tags 104 may be weighted according to frequency while the biographical tags 106 may be weighted according to a multiplier. Further, at a process block 204, a subset of the data set is determined. In one embodiment, the subset is determined by selecting an established number of tags from the data set. The order of the selection can be determined according to the weighting. In other words, the tags that have the highest weighting and that are within the established number of tags can be selected for the subset. In one embodiment, the established number of tags can be determined by the display view size of the display which depicts the personal cloud 102. At a next process block 206, the subset is sorted alphabetically. In addition, at a next process block 208, the tags in the personal cloud 102 are displayed according to the weighting. For instance, the content tags may be displayed in a font size corresponding to frequency where as the biographical tags 106 may be displayed in a font size, or color, that indicates biographical tags 106 so as to differentiate from the content tags 104.

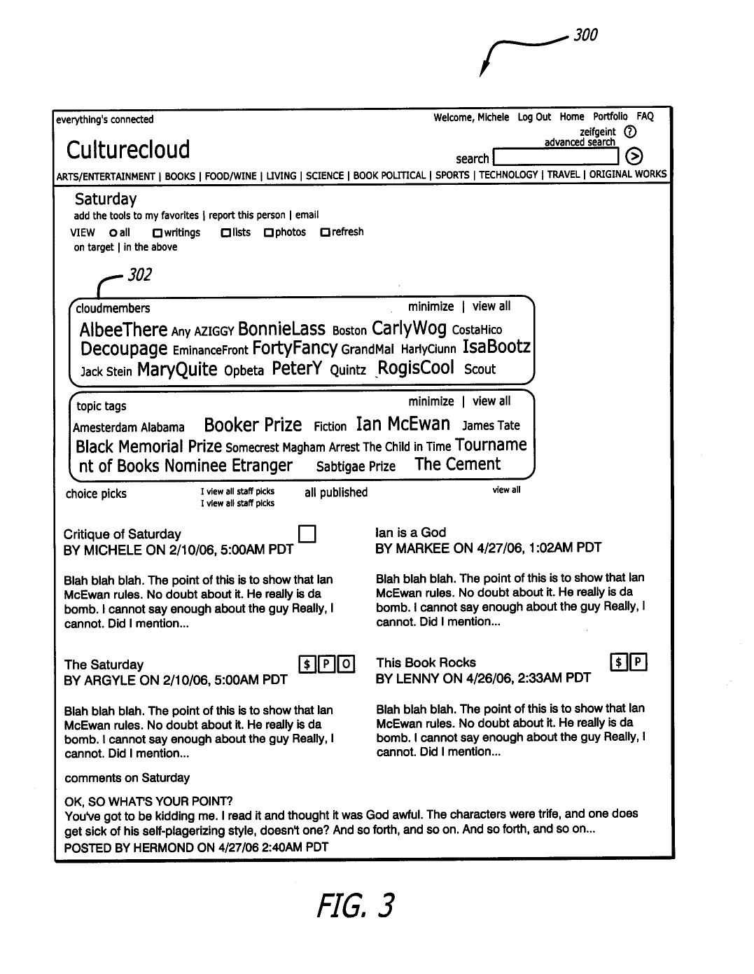

FIG. 3 illustrates a topic page 300, which can be composed from the content tags 104 of various personal pages 102. In other words, a topic page 300 can involve a topic that corresponds to a content tag 104 that is utilized by users to tag content. The topic page 300 can provide access to the different works that users have tagged with the topic of the topic page 300. For instance, a user can provide a writing, e.g., essay, list, or blog, photograph, audio, video, etc. on the topic page. Accordingly, users with common interests are more likely to find and interact with one another than in the friend model.

A topic page 300 can be created for almost any type of user interest. For instance, a topic page can be created for the topic of hybrid cars. Accordingly, users can post essays, blogs, photos, etc. regarding the topic of hybrid cars on the topic page.

In addition, the tags can correspond to topic pages. The tags are intended to provide a helpful description of the content so that other users can easily find the content on topic pages. For example, a topic page may be created for technology while another topic page may be created for computers. The user's essay can appear on each topic page. As will be described below, in one embodiment, a search engine can be provided to allow a user to search for a tag of interest to find other users that have utilized the tag and, thereby, may be interested in the same topic. In another embodiment, a search engine can be provided to allow a user to search for a tag of interest to find content.

Various information about the particular topic can be displayed on the topic page 300. For instance, the topic page 300 illustrated in FIG. 3 is directed towards the topic of a book entitled Saturday and displays information such as choice picks.

The topic page 300 has a cloudmember cloud 302. The cloudmember cloud 302 is a visual arrangement of the names of users who have tagged some content with a tag corresponding to the topic of the topic page 300. For instance, the topic page 300 illustrated in FIG. 3 is Saturday and, therefore, a user that has tagged content with the tag Saturday may appear in the cloudmember cloud 302. In one embodiment, the visual arrangement of the cloudmember cloud 302 is such that the frequency with which a user has utilized the topic as a tag is emphasized. For example, the name of a user who has utilized the tag Saturday one hundred times to tag one hundred different pieces of content can be emphasized with a larger font than a user who has utilized the tag Saturday only five times. The font can also be distinguished by type of font and/or color. In addition, the visual arrangement can provide this emphasis while displaying the names of the users in alphabetical order. Accordingly, other users can obtain a snapshot view of how interested different users are in a particular topic. Determining the interest level of a particular user can provide useful information on whether others users would like to interact with that particular user. For instance, some users may want to find users that have utilized the topic as a tag the most frequently because that may indicate a strong passion for the topic. User names with the largest sized font can be deduced from a visual review of the cloudmember cloud 302. On the other hand, some users may want to find users that have only a small interest in a particular topic to indicate awareness of the topic, but not a strong interest. User names with the smallest sized font can be deduced from a visual review of the cloudmember cloud 302. Further, some users may want to find other users that have an interest in a topic that is between a strong passion of the topic and an awareness of the topic. User names with medium sized font can be deduced from a visual review of the cloudmember cloud 302.

In one embodiment, a threshold value is determined for the number of tags that a user utilizes in order to appear in the cloudmember cloud 302. For instance, the threshold value can be five tags. A user that only tagged one piece of content with the tag would not appear in the cloudmember cloud 302. The threshold value helps maintain a reasonable number of user names in the cloudmember cloud 302 so that the size of the cloudmember cloud 302 does not become too cumbersome for a visual review.

In another embodiment, the user can be provided with a minimize button or other user interface to allow the user to minimize the cloudmember cloud 302. In one example, the cloudmember cloud 302 can be minimized to only display a predetermined number of tags. In another example, the cloud member cloud 302 can be minimized to only display tags having a specific relevant importance or weight. In another embodiment, the user can be provided with a show-all button or other user interface to allow the user to maximize the cloudmember cloud 302 to show all of the user names in the cloudmember cloud 302.

Once a user identifies another user from the cloudmember cloud 302 that may have similar interests, the user may want to learn more about and possibly interact with the user whose name appears in the cloudmember cloud 302. In one embodiment, each of the user names appearing in the cloudmember cloud 302 is a hyperlink that can provide access to the personal page 100 for the user whose names appears in the cloudmember cloud 302.

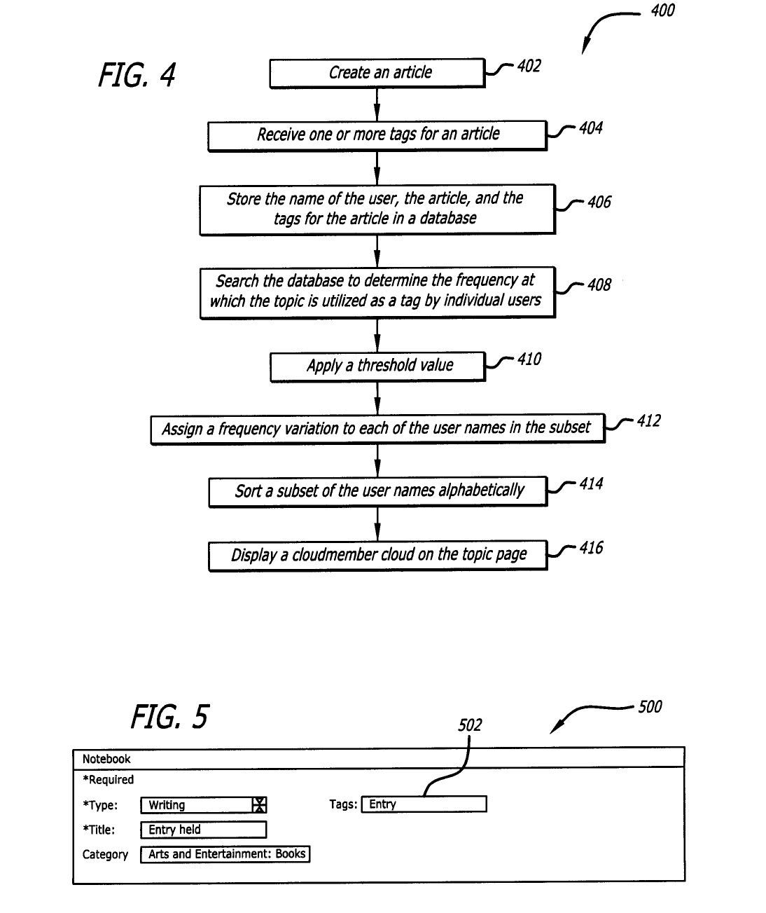

FIG. 4 illustrates a process 400 that creates the cloudmember cloud 302. At a process block 402, a user creates content. Further, at a process block 404, one or more tags are received for the particular content. As described above, a user may input the tags through an input box. In addition, at a process block 406, the name of the user, the content, and the tags for the content can be stored in a database. At a next process block 408, a search of the database is performed for each topic page to determine the frequency that the topic is utilized as a tag by individual users. For instance, a search of the database can be performed to narrow down the database entries to those entries having a tag that corresponds to the topic. From those entries, the number of times that a user's name appears will indicate the frequency with which a user utilized the topic as a tag. Further, at a process block 410, the threshold value is applied so that a subset of the user names appearing in the entries from the search are chosen. For example, if the threshold value is five, only the members that have utilized a topic as a tag at least five times will have a user name that is displayed in the cloudmember cloud 302. In addition, at a process block 412, a frequency variation is assigned to each of the user names in the subset. At a next process block 414, the subset of the user names is sorted alphabetically. The frequency variation indicates the frequency for which the user associated with a user name utilized the topic of the topic page as a tag. For instance, if five possible frequency variations exist, a frequency variation of a five may indicate that a user was one of the most frequent users in the subset to tag content with the topic while a frequency variation of a one may indicate that a user was one of the least frequent users in the subset to tag content with the topic. Each frequency variation can have an associated font size. For instance, a frequency variation of five can have an associated font size that is larger than any of the other frequency variations. Finally, at a process block 416, the cloudmember cloud 102 is displayed on the topic page. The visual arrangement of the user names is determined according to the frequency variations.

FIG. 5 illustrates an input display 500. The input display 500 has an input box 502 that can be utilized to input one or more tags for a piece of content that the user uploads.

Display Cloud

As referenced herein, a display cloud can be any tag cloud that is displayed upon a user hovering or rolling with a pointing device (e.g., a mouse) over an item on a webpage. The display cloud includes tags that are related to the item on the webpage. In addition, the item on the webpage can be an image, a hyperlink, a tag cloud, or any other user interface mechanism.

In one embodiment, the display cloud can be displayed upon hovering or rolling over a username. For example, the display cloud can be displayed upon hovering over a username that is part of a cloudmember cloud. In another example, the display cloud can be displayed upon hover over a hyperlinked username. For example, a plurality of names may appear on the web page such that a user can rollover the different names to see a display cloud for the user associated with the user name.

Furthermore, the tags displayed in the display cloud can include biographical tags, content tags, tags showing usernames of contacts of the person, a combination thereof, etc. In one example, the display cloud includes only some of the tags associated with an individual. Accordingly, the user can see a subset of the personal cloud of another user.

In another embodiment, the display cloud can be displayed upon hovering or rolling over a user interface item representing content, such as media. The display cloud can be displayed, for example, upon rolling on a video clip. The tags displayed in the video clip can vary. In one example, the display cloud can be a cloudmember cloud that shows the individuals in the credits of the video clip. In another example, the display cloud can include tags of topics related the video clip. Many other examples exist.

In another embodiment, the display cloud can be displayed upon hovering or rolling over an image. In another embodiment, the display cloud can be displayed upon hovering or rolling over a hyperlink.

Again the display cloud can include a cloudmember cloud, a related topics cloud, etc. Therefore, the display cloud is not limited to include a specific type of tag. In other words, any other types of tags can be utilized in the display cloud. Further, other types of tags can be utilized for any of the clouds described herein. In addition, searches can be performed on other types of tags.

As such, a user may rollover a hyperlink or any other item that has an associated display cloud to see the display cloud in order to determine if there is interest in viewing the hyperlink.

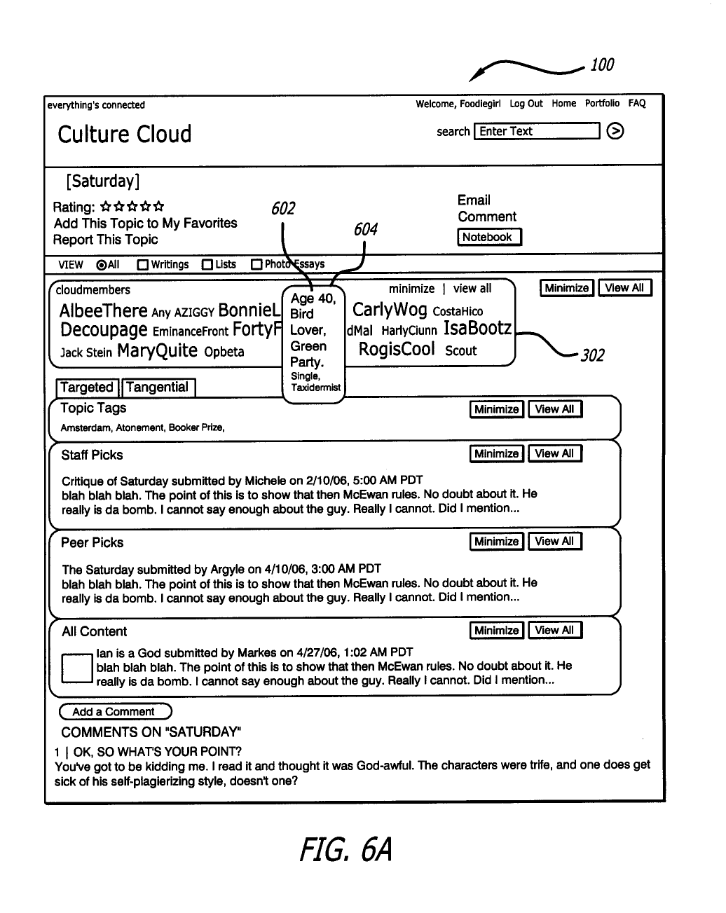

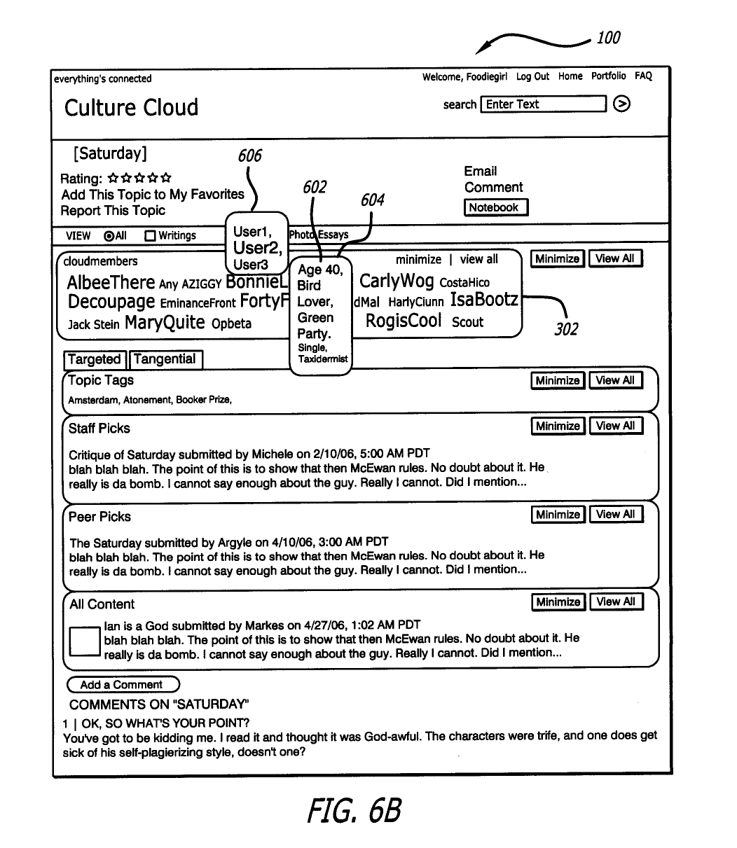

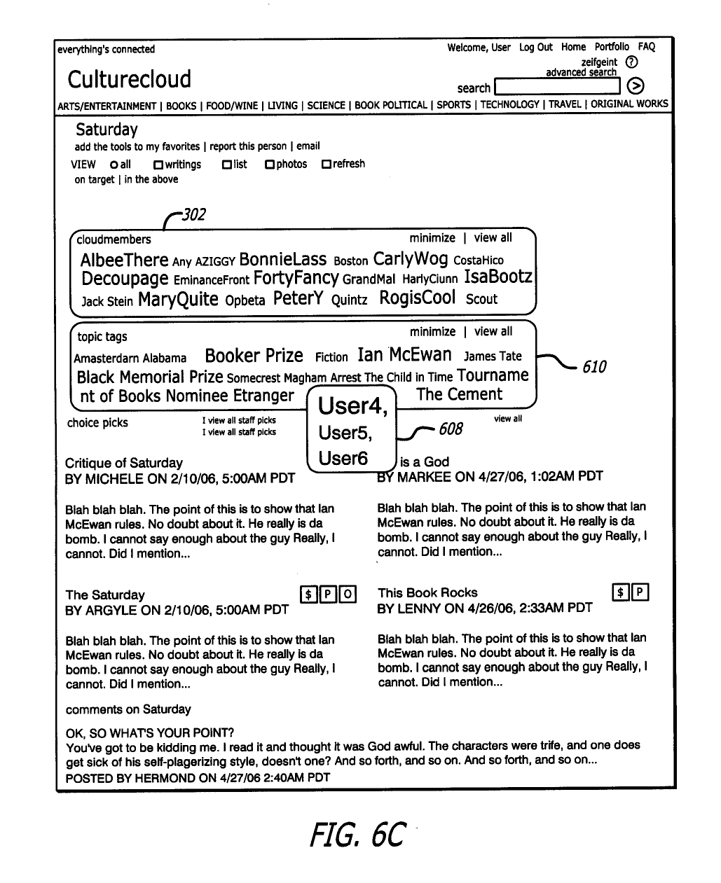

FIG. 6A illustrates an exemplary display cloud 602 that can be displayed in conjunction with the cloudmember cloud 302 on the topic page 300. The display cloud 602 can provide a supplemental display for a user name appearing in the cloudmember cloud 302. In other words, an additional display can be provided with respect to a particular user whose name appears in the cloudmember cloud 302 so that information about the user can be obtained before actually going to the personal page 300 of the user. For example, a user viewing the cloudmember cloud 302 can utilize a computer mouse to roll a mouse pointer over a user name appearing in the cloudmember cloud 302. As a result, a balloon 604 can be displayed which illustrates the display cloud 602. The display cloud 602 includes at least a portion of the personal cloud 102 that appears in the personal page 100 of the user whose name appears in the cloudmember cloud 302. Accordingly, a user viewing the balloon 604 can view content tags and biographical tags of the user to determine if there is interest in going to the personal page 100 of the user whose name appears in the cloudmember cloud 302, e.g., by clicking a hyperlink in the cloudmember cloud 302 indicating the user name. Consequently, a user can peruse the user names in the cloudmember cloud 102 and learn a lot about the users without having to view each one of the individual personal pages. Accordingly, the display cloud 602 provides for an efficient way of quickly determining potential interest for interaction. In another embodiment, content tags for the particular content and biographical tags are received. Both the content tags and the biographical tags are utilized to form the personal cloud 102. In one embodiment, a subset, including content tags and biographical tags, of the personal cloud 102 can be utilized for the display cloud 602. In one embodiment, the subset can be generated by selecting a predetermined number of biographical tags 106 and a predetermined number of content tags 104. The selected biographical tags 106 and content tags 104 are then mixed and arranged in alphabetical order to be displayed in the display cloud 602. In one embodiment, the content tags are selected for the display cloud 602 by determining the most frequently utilized tags. Further, the biographical tags 106 can be randomly selected. In yet another embodiment, both the content tags 104 and the biographical tags 106 are selected randomly. In another embodiment, all the content tags and biographical tags of the personal cloud 102 are utilized for the display cloud 602.

In yet another embodiment, biographical tags are received. In one embodiment, a subset, including biographical tags, of the personal cloud 102 can be utilized for the display cloud 602. In one embodiment, the subset can be generated by selecting a predetermined number of biographical tags. In one embodiment, the predetermined number of biographical tags can be selected by the user associated with the personal cloud 102. In other words, the user associated with the personal cloud 102 can determine what biographical tags are seen in the display cloud. Accordingly, the user associated with the personal cloud 102 can determine which biographical tags best describe the user. In another embodiment, the biographical tags can be randomly selected.

FIG. 6B illustrates an exemplary additional display cloud 606 that can be displayed in conjunction with the display cloud 604. Tags within a display cloud can in turn be associated with the additional display cloud 606. In one example, the display cloud 604 can have a biographical tag for “Age 40.” If the user, the hovers over the “Age 40” tag, an additional display cloud 606 can also be displayed to show usernames of users related to the tag “Age 40.” In another example, if a display cloud includes a username tag, a user may rollover the username tag to trigger the display of yet another display cloud. This mechanism can be implemented recursively such that a user can view one display cloud after another until the user finds an item of interest.

FIG. 6C illustrates an exemplary additional display cloud 608 that can be displayed in conjunction with a topic tag cloud 610. The topic tag cloud 610 can include tags that can be hovered over or pointed to by a pointing device. In one example, the display cloud 608 can include usernames corresponding to users who have utilized the tag being referenced. In another example, the display cloud 608 can include content tags associated with the tag being referenced.

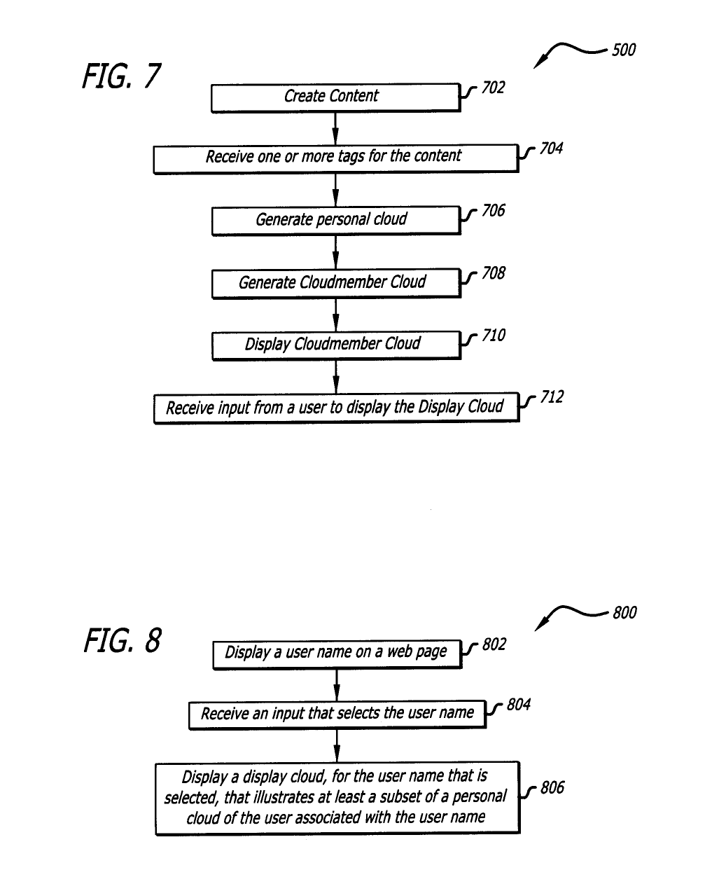

FIG. 7 illustrates a process 700 that creates a display cloud 602. At a process block 702, a user creates content. Further, at a process block 704, one or more tags are received for the particular content. In addition, at a process block 806, a personal cloud 102 is generated, as described with respect to FIG. 6. Further, at a process block 708, a cloudmember cloud 302 is generated, as described with respect to FIG. 3. At a process block 710, the topic page 300 with the cloudmember cloud 302 are displayed. Further, at a process block 712, an input is received from a user to display the display cloud 602. For instance, the input can be the utilization of a computer mouse to perform a rollover on a hyperlink for a user name in a web page. In one embodiment, the display cloud 602 displays only a subset of the personal cloud 102. In another embodiment, the display cloud 602 displays the entire personal cloud 102. Finally, at a process block 714, the display cloud 602 is displayed.

FIG. 8 illustrates a process 800 for displaying a display cloud. At a process block 802, the process 800 displays a user name on a web page. Further, at a process block 804, the process 800 receives an input that selects the user name. In addition, at a process block 806, the process 800 displays a display cloud, for the user name that is selected, that illustrates at least a subset of a personal cloud of the user associated with the user name.

Multilevel Tagging

In another embodiment, multi-level tags can be provided to allow a user to tag a piece of content with different types of tags. For instance, a first level tag may be a main topic tag and a second level tag may be a related tag. The main topic tags for a piece of content can include the terms that are most related to the piece of content. For instance a main topic tag can be a title, name of a creator, place, or thing. The related tags for a piece of content can include terms that are directed towards concepts that go beyond the literal subject of the piece of content. For instance, a related tag can be a theme of a piece of content. For example, the theme can be ethics, redemption, man vs. nature, tradition vs. progress. Further, the related tag can be subject matter. For example, the subject matter can include government and the arts, public health, immigration, etc. In addition, the related tag can be other works by the same creator. These examples are intended to be illustrative, not exhaustive.

The related tags allow users to see the topics of interest of others and the viewpoints that others have which stem from that topic. Accordingly, the related tags allow users to find other users who may think about a topic in a different yet interesting way.

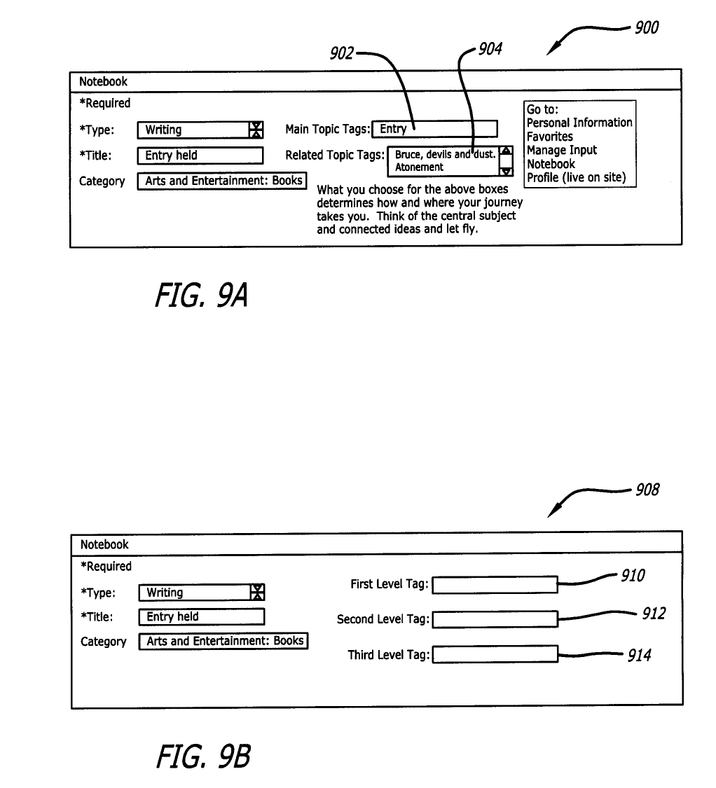

FIG. 9A illustrates an input box 900 that allows a user to input one or more main topic tags 902 and one or more related tags 904 for a piece of content. Accordingly, clouds can be formed from tags that a user utilizes for main topic tags 902 and/or related tags 904.

FIG. 9B illustrates an input box 908 that allows a user to input one or more levels of tags for a piece of content. A first level tag field 910 can be provided for a user to enter one or more first level tags. A second level tag field 912 can be provided for a user to enter one or more second level tags. A third level tag field 914 can be provided for a user to enter one or more third level tags.

A user may utilize multiple levels of tags to tag content. In one embodiment, two levels of tags a user may utilize, namely a first level having corresponding first level tags, and second level having corresponding second level tags. Various configurations and combinations of tagging within a two-level model can be utilized. For example, the first level tags can include main topic tags that are associated directly to main topics in the content being tagged. Moreover, the second level tags can include related tags that are associated with ancillary, collateral topics associated to the content being tagged.

Rules of tag interaction can further be developed. For example, a rule can be established where within the first level there can be at most two first level tags. In addition, another rule can be established wherein the second level can have at most five tags.

Tags within a same level can be referred to as companion tags. For example, when referring to a first level tag used to tag a particular content, other first level tags are companion tags of the first level tag. Likewise, when referring to a second level tag used to tag a particular content, other second level tags are companion tags of the second level tag level tag. For instance, if a User tags an article with the first level tags “Bruce Springsteen” and “Born in the USA,” and the Tag being referenced is “Bruce Springsteen”, then the tag “Born in the USA” can be said to be a companion tag. In addition, if the article is further tagged with related tags “Rock” and “American” and the tag being referenced is “Rock,” then the tag “American” can be said to be a companion tag.

In another embodiment, there can be three levels of tags to tag content. In yet another embodiment, there can be four levels of tags to tag content. In yet another embodiment, there can be any number of levels to tag content. In one example, the user can define the number of levels to tag content.

Multiple levels of tagging of content can be utilized in multiple ways. In one embodiment, multiple levels of tagging can be utilized on a topic web page that displays one or more clouds according to the levels of the tags.

In one example, a cloudmember cloud can be displayed, where the cloudmember cloud displays usernames of users who have tagged their content with a first level tag that matches the topic of the topic page.

In another example, a cloudmember cloud can be displayed, where the cloudmember cloud displays usernames of users who have tagged their content with a second level tag that matches the topic of the topic page.

In yet another example, if one of the first level tags of a piece of content matches the topic of the topic page, then a direct tag cloud can be displayed to include the companion tags of the one of the first level tags, as well as tags of other levels (e.g. second level tags).

In another example, if one of the second level tags of a piece of content matches the topic of the topic page, then an indirect tag cloud can be displayed including the companion tags of the one of the second level tags, and the tags of other levels (e.g. first level tags).

In another example, content having first level tags that match the topic of the topic page can be displayed on the topic page. In another example, content having second level tags that match the topic of the topic page can be displayed on the topic page. As previously mentioned, the number of levels of tagging can be customized and therefore can be any number desired (e.g., two levels, three levels, four levels, five levels, etc). As such, more than two levels can be utilized for multilevel tagging. For example, three levels of multilevel tagging can be utilized. Each level can be related to other tags on the same level in addition to being related to tags from other levels. For instance, a first level tag can be related in a particular way to other first level tags, but can be related in different ways to second level tags and third level tags. The example of three levels of tagging is meant to be illustrative, not exhaustive.

For exemplary purposes only, a topic page having as the topic “Saturday” can be utilized. In addition, one or more views can be configured so as to present users, content and clouds in an organized fashion. For example, a direct view that shows clouds of users and tags, as well as content that is directly relevant to the topic of the topic page can be available. In another example, an indirect view that shows clouds of users and/or tags, as well as content that is indirectly relevant to the topic of the topic page can also be available. Based on multi-level tagging of content, more relevant content can be provided to a user. For example, tags in tagging levels that are more relevant to the content can be utilized to show content that is closely related to a topic being searched or reviewed by the user. In addition, tags in tagging levels that are not so relevant to the content can be utilized to show content that is remotely related to a topic being searched or reviewed by the user.

A cloudmember cloud can be displayed on the topic page. The cloudmember cloud can include user identifiers corresponding to users who have most frequently utilized the topic of the topic page or topic to tag their content with a first level tag. In addition, a direct tag cloud can be created to visually illustrate the most frequently used first level companion tags and second level tags from content which has a first level tag that matches the topic of the topic page.

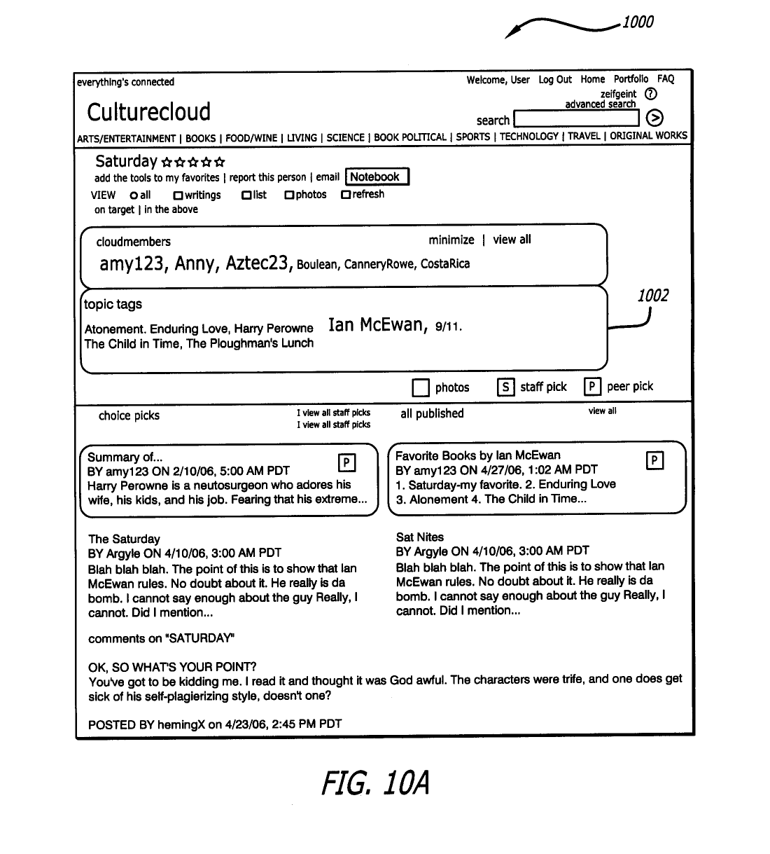

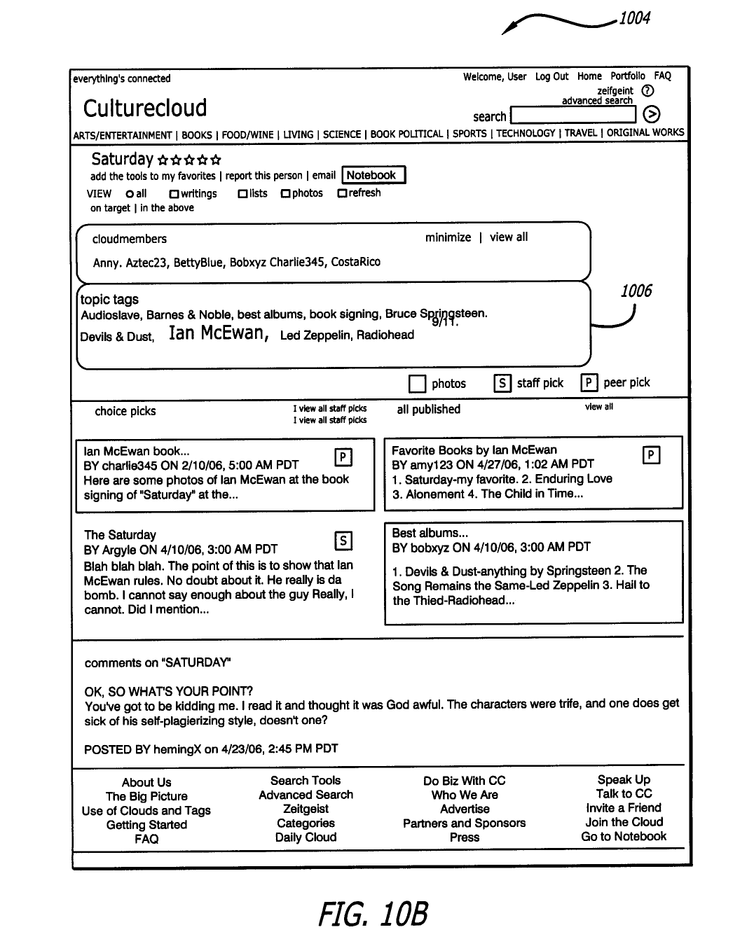

FIG. 10A illustrates a direct view of a topic page. As can be seen from FIG. 10A, the most frequent first level companion tags and second level tags from content which has a first level tag that matches the topic page's topic are displayed in a direct tag cloud 1002 on a web page 1000. For instance, the topic page's topic is “Saturday” and one of the visually illustrated first level companion tags is “Ian McEwen,” which was utilized as a companion tag in some or many pieces of content in the site.

As mentioned above, a cloudmember cloud on a topic page can be created to display the users who have most frequently utilized the topic of the topic page to tag their content with second level tags. Further, an indirect tag cloud can also be created to visually illustrate the most frequently used first level tags and companion second level tags for content which has a second level tag that matches the topic page's topic.

FIG. 10B illustrates an indirect view of a topic page. As can be seen from FIG. 10B, the most frequent first level tags and companion second level tags for content which has a second level tag that matches the topic page's topic are displayed in indirect tag cloud 1006 on a web page 1004. For instance, the topic of the topic page is “Saturday” and one of the visually illustrated companion first level tags is “Bruce Springsteen,” which was utilized as a companion second level tag in some or many pieces of content in the site.

In one embodiment, the view of the direct tag cloud illustrated in FIG. 10A illustrates the most frequently used first level companion tags and the second level tags from content which has a first level tag that matches the topic page's topic. Further, the view of the indirect tag cloud illustrated in FIG. 10B illustrates the most frequently used first level and second level companion tags from content which has a second level tag that matched the topic page's topic.

Further, a user can toggle between the views illustrated in FIG. 10A and FIG. 10B. In other words, the user can view a topic page and the direct tag cloud of the most frequent companion first level tags and second level tags from content which has a first level tag that matches the topic of the topic page. Further, the user can click to an alternate topic page view to see the indirect tag cloud of the most frequent first level tags and second level companion tags from content which has a second level tag that matches the topic of the topic page. In FIGS. 10A and 10B, the user can toggle between the direct view and the indirect view for the topic “Saturday.”

Multilevel tagging allows users to interact with other users that they would potentially have never interacted with. In one example, the topic page cloud 1002 allows a user to see users that have utilized the exact tag corresponding to the topic of the topic page 300. In another example, users can further interact with users who have utilized tags related to the topic to tag content as second level tags.

In addition, the ability to toggle between the direct view and the indirect view allows a user to choose a level of interaction. The user, at one time, may feel like interacting with users who have utilized the topic tag as a first level tag while the user, at another time, may feel like interacting with users who have utilized the topic tag as a second level tag.

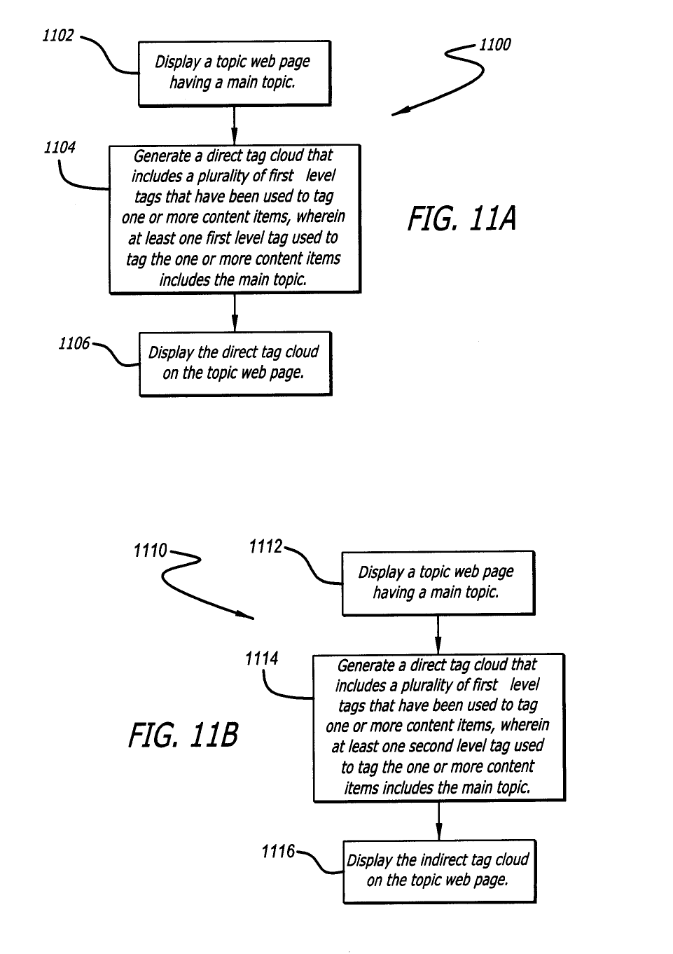

FIG. 11A illustrates a process 1100 for interrelating content that has been tagged with multilevel tags according to one embodiment. At process block 1102, a topic web page having a main topic can be displayed. The process 1100 continues at process block 1104. At process block 1104, a direct tag cloud is displayed. The direct tag cloud can include a plurality of first level tags and a plurality of second level tags that have been used to tag one or more content items. At least one first level tag used to tag the one or more content items includes the main topic. The process 1100 continues at process block 1106. At process block 1106, the direct tag cloud is displayed on the topic web page.

FIG. 11B illustrates a process 1110 for interrelating content that has been tagged with multilevel tags according to another embodiment. At process block 1112, a topic web page having a main topic is displayed. The process 1110 continues at process block 1114. At process block 1114, an indirect tag cloud that includes a plurality of first level tags and a plurality of second level tags that have been used to tag one or more content items is generated. At least one second level tag used to tag the one or more content items includes the main topic. The process 1110 continues at process block 1116. At process block 1116, the indirect tag cloud is displayed on the topic web page.

In one embodiment, the multilevel tags can be weighted according to frequency. In other words, a first level tag and a second level tag are each weighted according to frequency of use. In another embodiment, a weighting may be provided between each level of tags. For instance, a first level tag may be weighted differently than a second level tag. In yet another embodiment, the multilevel tags may each be weighted according to frequency and according to level. For example, a first level tag with the same frequency of use as a second level tag may be weighted differently because of the difference in levels, e.g., the first level tag may be visually displayed in a larger font size than the second level tag.

Tag Searching

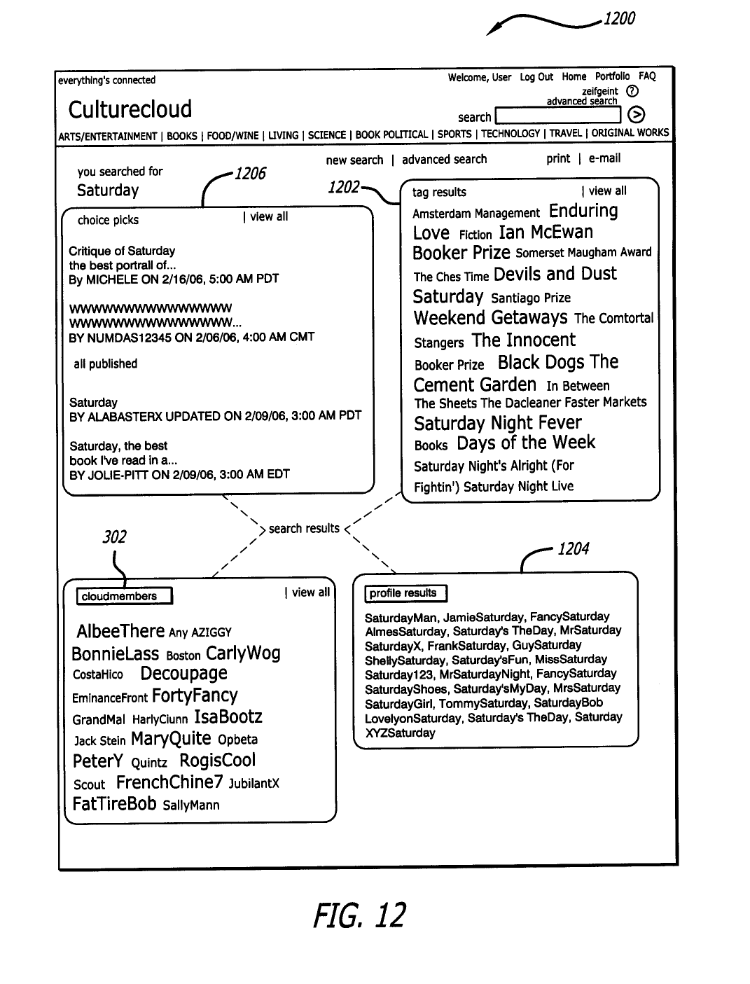

Further, a search engine can be utilized to search for a tag. In one embodiment, the search results include both users and content that are related to the tag in some manner. FIG. 12 illustrates a web page 1200 that depicts the search results from a search for the tag. The cloudmember cloud 302 can display members who have utilized the tag. In addition, the content listing 1206 displays the content that has been tagged with the search term. In one example, the content displayed in the content listing 1206 corresponds to content that includes multilevel tagging, and that was tagged with the search term at a first level tagging. In another example, the content displayed in the content listing 1206 corresponds to content that includes multilevel tagging, and that was tagged with the search term at a second level tagging. In one yet another example, the content displayed in the content listing 1206 corresponds to content that includes multilevel tagging, and that was tagged with the search term at any level of tagging.

In one embodiment, all of the content tagged with the search term can be viewed. In another embodiment, a subset of the content can be viewed, and an expanded view can be provided to view all the content. In another embodiment, selected content of various users for viewing. In one embodiment, operators of the social networking environment can select the content for the selected content. For example, “Choice Picks” can be provided.

In addition, a tag search cloud 1202 can display tags that include the search term or tags that are companion tags of the tag being searched. The displayed tags are tags that users have utilized to tag content. In the example of a companion tag discussed above, Born in the USA was a companion tag to the tag Bruce Springsteen. Both the tag being searched, Bruce Springsteen, and the companion tag, Born in the USA, will appear in the tag search cloud 1202. Similarly, the companion tags of other users, e.g. a user who tagged content with “Bruce Springsteen” and “Born to Run,” will also appear in the tag search cloud 1202. A member name list 1204 can be displayed to indicate which members have utilized the text of the search term as part of his or her user name.

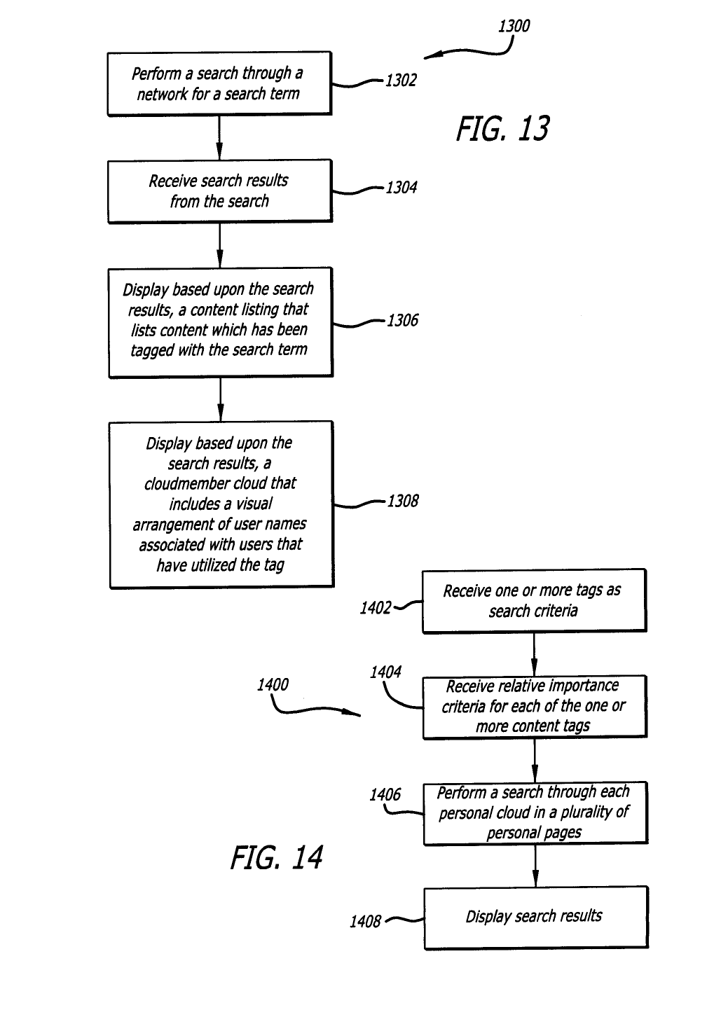

FIG. 13 illustrates a process 1300 that displays search results from searching for a search term. At a process block 1302, the process 1300 performs a search through a network for a search term. As previously mentioned, if the content is tagged with multiple levels of tagging, different configurations of searching can be utilized. For example, the search term may only be searched within the first level of tagging of the content. In another example, the search term may only be searched within the second level of tagging of the content. In another example, the search term may be searched within the first, the second and the third level of tagging of the content. In another example, the search term may be searched within any level of tagging of the content.

At a next process block 1304, the process 1300 receives search results form the search. Further, at a next process block 1306, the process 1300 displays, based upon the search results, a content listing that lists content which has been tagged with the search term.

In addition, at a next process block 1308, the process 1300 displays, based upon the search results a cloudmember cloud that includes a visual arrangement of user names associated with users that have utilized the search term as a tag.

Cloud Searching

In yet another embodiment, a cloud matching system and method are provided. A user can search for a list or a cloud of interest. In other words, a user can search for a particular kind of person represented by a particular kind of cloud. For instance, a user can search for an individual represented by a personal cloud of interest having one or more content tags and for a specified frequency for those content tags. The user can also search for a person whose cloud contains one or more biographical tags. This can be particularly useful to advertisers, recruiters, matching services for singles, individuals searching for other individuals with similar interests, etc.

Accordingly, the user can search for a theoretical user, having a prescribed set of traits, characteristics, and/or interests, that the user would potentially be interested in interacting with. In addition, the user can search for a personal cloud having specific frequency of biographical tags, content tags, or any other type of tag.

A user can provide search criteria to locate another person of interest. The search is performed through the personal clouds on the personal pages of different users to find a particular tag or set of tags. A list of the users with personal clouds having the tags indicated by the search criteria will then be displayed. In one embodiment, the search results are provided in a cloud format. In other words, the list of names is displayed in a visual arrangement, e.g., an alphabetical listing with different sized fonts corresponding to the number of search criteria met. The correspondence can also be based on a correlation to the search criteria.

For example, a set of search criteria can include a set of traits that are required to be in the cloud. Furthermore, the set of search criteria can include a set of traits that can be useful to have in the cloud but are not required. In another embodiment, the search criteria can include the weight for each of the traits being searched for. For example, a first trait may be required to have a specific weight, while a second trait may be permissible to have the minimum weight.

FIG. 14 illustrates a process 1400 that provides cloud matching. At a process block 1402, the process 1400 receives one or more content tags as search criteria. In another embodiment, the process 1400 receives one or more tag tags as search criteria. The tags received for searching can be biographical tags, content tags, or any other tags or combination of tags. Further, at a process block 1404, the process 1404 receives the relative importance criteria for each of the one or more content tags. The relative importance criteria may include an exact match, a minimum threshold, and/or a maximum threshold for the frequency for a particular tag. In another example, the relative importance criteria may include the weight of the particular tag. In addition, at a process block 1406, a search is performed through each personal cloud of a plurality of personal pages to determine which personal clouds meet the search criteria. At a process block 1408, the search results are displayed. In one embodiment, a list of hyperlinks for users with personal clouds meeting the search criteria is illustrated. The hyperlink can be selected to go to the personal page of the user. In another embodiment, a list of the personal clouds meeting the search criteria can be illustrated. A hyperlink can be positioned in proximity to each personal cloud in the list so that the corresponding personal page can be accessed.

In another embodiment, the matching system and method is not limited to clouds. Accordingly, the matching system and method can also search through lists of content tags and/or biographical tags based on tags that a user requests as part of the search.

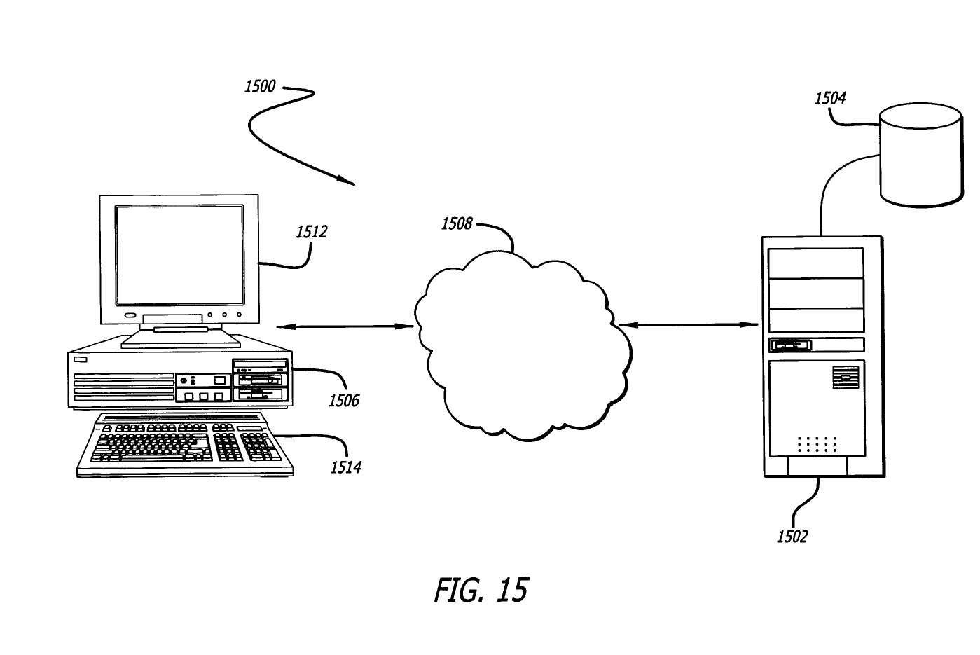

FIG. 15 illustrates a system 1500 that can be utilized to create the clouds described herein. The system 1500 includes a web server 1502 that hosts a web page, e.g., the topic page 300. Further, the web server 1502 can retrieve user names and frequency variations from an associated database 1504. In addition, the database 1504 can store other web pages described herein. The web server 1502 determines visual arrangement for cloudmember cloud 302 by accessing the database 1504 and processing information such as the frequency variations. The web server 1502 can then place the cloudmember cloud 1002 in the topic page 300 and send the topic page 300 to a computer 1506 through a network 1508. The network 1508 can be the Internet, a local area network, or any other network known to one of ordinary skill in the art. The computer 1506 has an associated display 1510 which can then display the topic page 100 to a user. Further, the user can utilize an input device 1514 to input information, such as content and tags for the content, to be transmitted to the web server 1502 through the network 1508.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of social networking, the method comprising:
displaying a user name on a web page;
receiving an input that selects the user name; and
displaying a display cloud, for the user name that is selected, that illustrates at least a subset of a personal cloud of the user associated with the user name.

2. The method of claim 1, wherein a hyperlink is displayed for the user name.

3. The method of claim 1, wherein the personal cloud appears on a personal page of the user that is selected.

4. The method of claim 1, wherein the user input is received from a computer mouse.

5. The method of claim 4, wherein the user input is a rollover of the user name with a mouse pointer that corresponds to movement of the computer mouse.

6. The method of claim 1, wherein the user name is displayed in a cloud.

7. The method of claim 6, wherein the cloud includes additional user names.

8. The method of claim 1, wherein the web page is a topic page.

9. A method of social networking, the method comprising:
providing a search engine that searches through a plurality of personal clouds, each of the personal clouds being displayed on a personal page and providing a visual display of tags that users have utilized to tag content;
receiving one or more tags as search criteria;
searching through the plurality of personal clouds for the one or more tags; and
generating a set of search results based on the search.

10. The method of claim 9, wherein the search criteria is ranked according to a preference of a user.

11. The method of claim 9, further comprising transmitting the set of search results to a client computer so that the client computer can display search results.

12. The method of claim 9, wherein the search results are user names that are associated with users having personal clouds that meet the search criteria.

13. The method of claim 9, wherein the search results are personal clouds of individuals that meet the search criteria.

14. The method of claim 9, wherein the one or more tags include content tags.

15. The method of claim 9, wherein the one or more tags include biographical tags.

16. The method of claim 9, wherein the one or more tags include content tags and biographical tags.

17. A method of interrelating content in a computer network, comprising:
displaying a topic web page having a main topic;
generating a direct tag cloud that includes a plurality of first level tags and a plurality of second level tags that have been used to tag one or more content items, wherein at least one first level tag used to tag the one or more content items includes the main topic; and
displaying the direct tag cloud on the topic web page.

18. The method of claim 17, further comprising generating a direct cloudmember cloud that includes user tags corresponding to users who have used a first level tag to tag content of each user, wherein the first level tag includes the main topic.

19. The method of claim 17, further comprising:
generating an indirect tag cloud that includes a plurality of first level tags and a plurality of second level tags that have been used to tag one or more content items, wherein at least one second level tag used to tag the one or more content items includes the main topic; and
displaying the indirect tag cloud on the topic web page.

20. The method of claim 19, further comprising generating a direct cloudmember cloud that includes user tags corresponding to users who have used a first level tag to tag content of each user, wherein the first level tag includes the main topic.

21. The method of claim 19, further comprising displaying the topic web page using a direct view and an indirect view, wherein the direct view includes the direct tag cloud, and the indirect view includes the indirect tag cloud.

22. The method of claim 17, further comprising displaying at least one hyperlink to the one or more content items in the topic page.

23. The method of claim 17, wherein a first level tag is a tag utilized to tag a piece of content and is descriptive of a main feature of the piece of content.

24. The method of claim 17, wherein a second level tag is a tag utilized to tag a piece of content and is descriptive of a secondary feature of the piece of content.

25. A method of social networking, the method comprising:
performing a search through a network for a search term;
receiving search results from the search;
displaying, based upon the search results, a content listing that lists content which has been tagged with the search term; and
displaying, based upon the search results, a cloudmember cloud that includes a visual arrangement of user names associated with users that have utilized the search term as a tag.

26. The method of claim 25, further comprising displaying, based upon the search results, a tag search cloud that includes the tag and one or more companion tag.

27. The method of claim 25, further comprising displaying a member name list that indicates members that have utilized the text of the tag as part of a user name.

28. A user interface for displaying content, comprising:
a webpage item being displayed and selectable with a pointing device; and
a pop-up display section that is displayed upon the webpage item being hovered over by the pointing device, the pop-up display section including at least one first tag that is displayed with high visibility, and at least one second tag that is displayed with less visibility than the at least one first tag, the at least one first tag being more relevant to the web page item than the at least one second tag.

29. The user interface of claim 28, wherein the webpage item is a username displayed as part of a cloudmember cloud.

30. The user interface of claim 28, wherein the webpage item is a tag displayed as part of a tag cloud.

31. The user interface of claim 28, wherein the webpage item is an image displayed as part of a tag cloud.

32. The user interface of claim 28, wherein the pop-up display section is a tag cloud.

33. The user interface of claim 28, wherein the webpage item is a tag cloud.

34. A method of social networking, the method comprising:
performing a search through a network for a search term;
receiving search results from the search; and
generating a cloudmember cloud that includes a visual arrangement of user names associated with users that have utilized the search term as a tag.

35. The method of claim 9, further comprising transmitting the set of search results to a client computer so that the client computer can display search results on a webpage.

36. A method of social networking, the method comprising:
displaying a tag on a tag cloud, the tag cloud being displayed on a website;
receiving an input that selects the tag on the tag cloud; and
displaying a display cloud, for the tag that is selected, that illustrates at least a subset of additional tags corresponding to the content associated to the tag.

37. A method of referencing content on a website, comprising:
receiving at least one first level tag and at least one second level tag to tag a content item, wherein the at least one first level tag has a higher degree of relevance to the content item than the at least one second level tag; and
generating a tag cloud that displays one or more tags related to the content item, wherein at least a portion of the tags displayed in the tag cloud are at least partially weighted based on the degree of relevance of the at least one first level tag and the at least one second level tag to the content item.

38. The method of claim 37, wherein the tag cloud is a cloudmember cloud, a personal cloud, or a topic tag cloud.

39. The method of claim 37, wherein the tag cloud is related to the content item in that at least one username being used as a tag in the tag cloud corresponds to a user that tagged the content item.

40. The method of claim 37, wherein the tag cloud is related to the content item in that at least one biographical tag being used as a tag in the tag cloud corresponds to a user that tagged the content item.

41. The method of claim 37, wherein the tag cloud is related to the content item in that at least one topic tag being used as a tag in the tag cloud corresponds to a main topic of the content item.

42. The method of claim 37, wherein the tag cloud is related to the content item in that at least one topic tag being used as a tag in the tag cloud corresponds to a related topic of the content item.
